(19) United States
(12) Patent Application Publication
(10) Pub. No.: US 2011/0226570 A1
(43) Pub. Date: Sep. 22, 2011

(54) BRAKE ROTOR

(75) Inventor: Fritz LUDWIG, Michelfeld (DE)

(73) Assignee: REX INDUSTRIE-PRODUKTE GRAF VON REX GMBH, Vellberg (DE)

(21) Appl. No.: 13/051,242

(22) Filed: Mar. 18, 2011

(30) Foreign Application Priority Data
Mar. 19, 2010 (DE) 202010003882.0

(51) Int. Cl. F16D 65/12

(52) U.S. Cl. 188/218 XL

(57) ABSTRACT

The present invention relates to a brake rotor (10, 32, 38) which comprises a central inner region (12) of a first material composition of a fiber-reinforced thermoset (duroplast), which has a hub portion (16) with a concentric through-opening (20) for receiving a shaft to be braked, and an annular outer region (14), arranged concentrically on the central inner region (12), of a second material composition of a fiber-reinforced thermoset (duroplast), which has a braking portion (24) with a friction surface. The central inner region (12) and the annular outer region (14) are connected to each other with a material bond. The central inner region (12) is formed for transmitting high torques from the annular outer region (14) to the shaft to be braked, and the annular outer region (14) is optimized with regard to its tribological properties.

The invention relates to a brake rotor.

Brake rotors are usually connected in a rotationally fixed, axially displaceable manner to a shaft to be braked, braking being obtained by the brake rotor being clamped between two friction linings to varying degrees according to the desired braking action, in order to slow down the rotational speed of the shaft to be braked. Brake rotors of this type may be used, for example, as spindle brakes in textile machines, as quick-stopping brakes in electric servomotors or as coupling systems in mechanical engineering.

DE 60 2005 000 056 T2 discloses a brake disk for rail vehicles which has a hub provided with a supporting plate. Two brake friction plates, which form the actual contact friction surfaces, are arranged on the supporting plate in the form of a rim. The brake friction plates are connected to the supporting plate in a form-fitting or clampable manner by suitable connecting elements, such as for example screw bolts, rivets or adhesives.

DE 103 58 320 A1 already discloses friction bodies, which generally have a support or a support plate and at least one friction lining arranged on it. In this case, both the support and the at least one friction lining arranged on it consist of hardened friction materials based on reinforcing fibers, heat-curing binders and conventional fillers, so that the friction body is formed in one piece. Friction bodies of this type can be used as brake, clutch or other friction linings.

In the case of a brake rotor which is produced in one piece from a fiber-reinforced thermoset (duroplast) and the material composition of which is optimized to a high μ value and, depending on the application, even a moderate μ value, very high mechanical loading can lead to rupturing of the rotor, since the hub region of the brake rotor has a correspondingly low strength. The reason for this is that a friction material that has high compressibility, high extension under strain in strength tests along with high coefficients of friction, and as a result a low tendency for oscillations to be induced, cannot achieve high strengths.

The invention is therefore based on the object of providing a brake rotor which has a high strength in its coupling region with a shaft and a high coefficient of friction in a contact region with a brake body.

This object is achieved by the brake rotor as claimed in claim 1. Advantageous configurations and developments of the invention are specified in the subclaims.

In particular, the invention provides a brake rotor, comprising a central inner region of a first material composition of a fiber-reinforced thermoset (duroplast), which has a hub portion with a concentric through-opening for receiving a shaft to be braked, and an annular outer region, arranged concentrically on the central inner region, of a second material composition of a fiber-reinforced thermoset (duroplast), which has a braking portion with a friction surface, the central inner region and the annular outer region being connected to each other with a material bond, and it being possible for the central inner region to have a high internal strength and the annular outer region to have a high μ value, and also a moderate μ value, depending on the later application.

Therefore, the invention provides a brake rotor in which a radial inner portion and a radial annular outer portion of the brake rotor are produced from a similar support material, that is a fiber-reinforced thermoset, but the material composition of the radial outer portion additionally contains friction materials, which ensure that the surface of the outer portion has a moderate or high μ value. The two portions are connected to each other with a material bond, whereby the inner portion is optimized to high internal strength and the outer portion is optimized to a moderate or, depending on the application, high μ value. In spite of the different properties of the inner region and the outer region of the brake rotor, however, an integral rotor can nevertheless be produced from one and the same support material.

To obtain a central inner region with optimized strength, it is preferred if the first material composition of the fiber-reinforced thermoset has a density of 1.0 to 2.6 g/cm³, preferably 1.6 to 2.3 g/cm³ and particularly 2.1 g/cm³, a tensile strength of 50 to 200 N/mm², preferably 80 to 160 N/mm², and particularly 140 N/mm², a flexural strength of 70 to 300 N/mm², preferably 220 to 260 N/mm² and particularly 240 N/mm², and a compressive strength of 120 to 375 N/mm², preferably 300 to 350 N/mm², and particularly 325 N/mm².

When optimizing the material composition of the annular outer region arranged on the central inner region, it is of advantage if the second material composition of the fiber-reinforced thermoset has a density of 1 to 2 g/cm³, preferably 1.4 to 1.8 g/cm³ and particularly 1.6 g/cm³, a tensile strength of 10 to 100 N/mm², preferably 10 to 50 N/mm², and particularly 29 N/mm², a flexural strength of 10 to 100 N/mm², preferably 50 to 90 N/mm² and particularly 68 N/mm², and a compressive strength of to 150 N/mm², preferably 70 to 110 N/mm², and particularly 86 N/mm².

In a simple and preferred configuration of the invention, the first and second material compositions of the fiber-reinforced thermoset contain phenolic polymers, such as for example phenolic resin, phenolic/melamine resin or phenolic-resin-based epoxy resin, or aminoplastics, epoxy resin and/or crosslinked polyacrylates. Furthermore, the composition of the fiber-reinforced thermoset may include aminoplastic/phenolic-resin-modified compounds, both of which are connected to each other by way of methyl bridges (—CH2-), or methylene ether bridges, but also epoxy resins, crosslinked polyacrylates and further crosslinked polymers.

In order to optimize the brake rotor also with regard to its tensile and flexural strength, the first and second material compositions of the fiber-reinforced thermoset contain 10 to 60% by weight, preferably 20 to 50% by weight, of reinforcing fibers, with respect to the overall weight of the brake rotor.

Here it is expedient if the first and second material compositions of the fiber-reinforced thermoset contain organic and/or inorganic reinforcing fibers, the first and second material compositions of the fiber-reinforced thermoset containing as reinforcing fibers glass fibers, ceramic fibers, alumina fibers, carbon fibers, aramid fibers and/or metallic fibers, plus cellulose fibers and mineral fibers.

Here it is of advantage if the reinforcing fibers have an average fiber length of 3 to 15 mm, preferably of 5 to 10 mm.

To achieve a moderate or high μ value, required depending on the application, of the surface of the annular outer region of the brake rotor, it is advantageous if, along with the reinforcing fibers and a thermoset, the second material composition of the fiber-reinforced thermoset contains, as additives, lubricants such as graphite, special sulfur compounds (sulfides), inactive fillers, for example barium sulfite, calcium carbonate, or mixtures thereof, as well as organic-based active fillers such as resite, and inorganic active fillers such as nitrides, carbides, oxides, special sulfur compounds and crosslinked or uncrosslinked elastomers.

In order to achieve an optimal torsional strength between the brake rotor and the braking shaft, without impairing easy axial displacability of the brake rotor for quick activation of the brake, it is expedient if the inner circumferential surface of the through-opening in the hub portion is provided with driving means for rotationally fixed mounting on a shaft to be braked.

In principle, it is conceivable that the through-opening of the hub portion has any desired noncircular form—a triangle, square, flattening with axial groove or the like—which corresponds to the outer circumference of the shaft to be braked and is suitable for rotationally fixed mounting. However, it is advantageously provided that the driving means are formed by teeth for receiving shaft teeth on the shaft to be braked. Therefore, the inner circumferential surface of the through-opening in the hub portion preferably has teeth for receiving shaft teeth of the shaft to be braked.

In order to achieve an optimization of the weight and the mass moment of inertia of the brake rotor according to the invention, it is advantageous if both the central inner region and the annular outer region in the boundary region of the material-bonded transition between the first and second material compositions have a smaller thickness than that of the hub portion of the central inner region and that of the braking portion of the annular outer region.

In order to achieve a form fit between the central inner region and the annular outer region in addition to the material bond, allowing improved acceptance of shearing forces during braking that occur in the disk plane of the brake rotor, it is provided according to the invention that the central inner region has on its circumferential side one or more radially outwardly directed driver extensions, which are in form-fitting engagement with one or more radially inwardly directed driver extensions of the annular outer region.

In running tests with a circular form fit, no detrimental effects have been found at the transitions. The use of two materials appeared to be a major advantage. This reduced vibrations. In addition, the use of a number of semicircular transitions of a polygonal form can be envisaged.

However, instead of the driver extensions, it is also possible to provide irregular structures in the transitional region from the first material composition to the second material composition of the fiber-reinforced thermoset in the boundary region between the central inner region and the annular outer region, whereby a form fit can likewise be advantageously achieved between the two regions.

The invention is described below for example on the basis of exemplary embodiments that are represented in the drawing, in which:

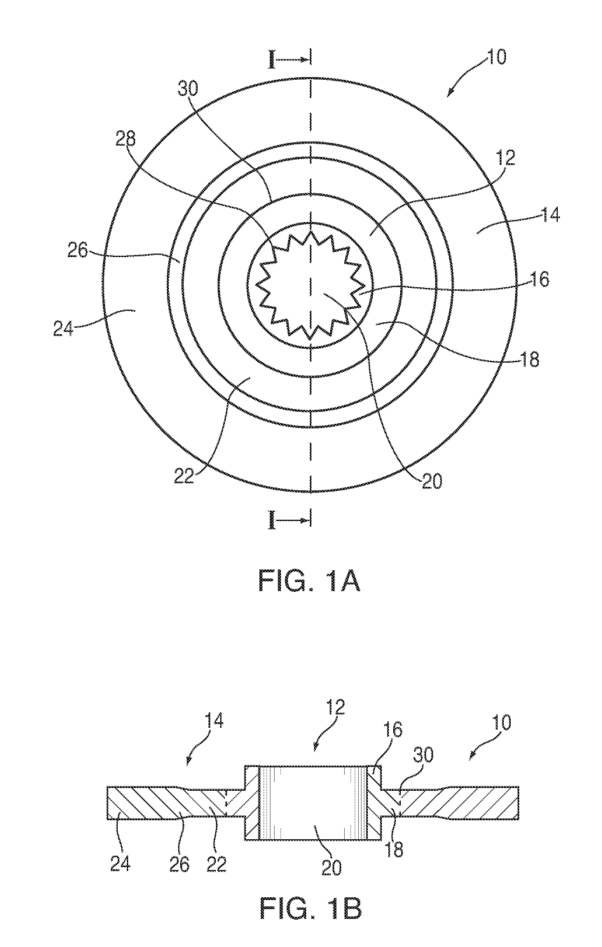

FIG. 1A shows a plan view of a brake rotor according to the invention as provided by a first exemplary embodiment of the invention;

FIG. 1B shows a section through the brake rotor according to the invention on line I-I in FIG. 1A;

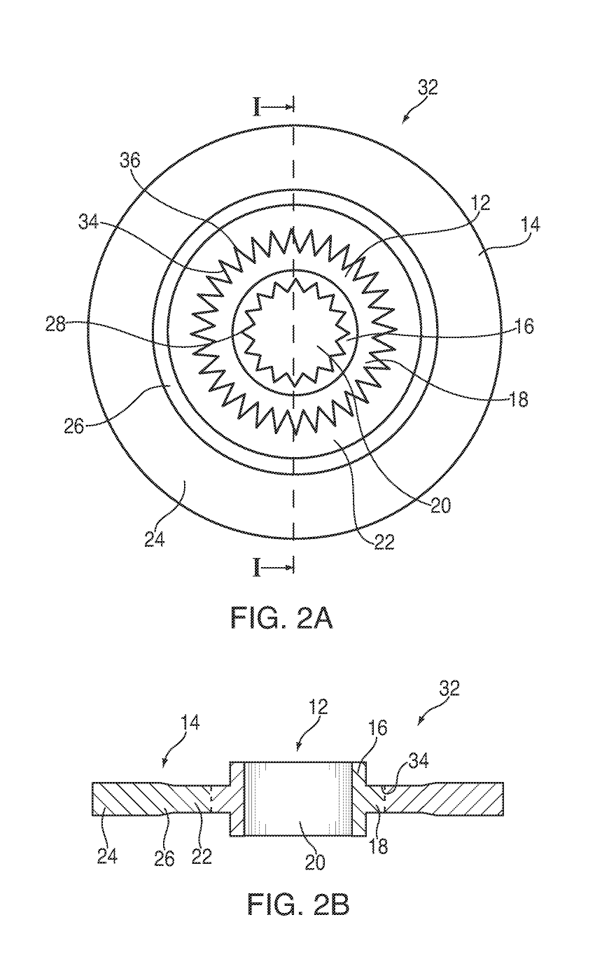

FIG. 2A shows a plan view of a brake rotor according to the invention as provided by a second exemplary embodiment of the invention;

FIG. 2B shows a section through the brake rotor according to the invention on line I-I in FIG. 2A;

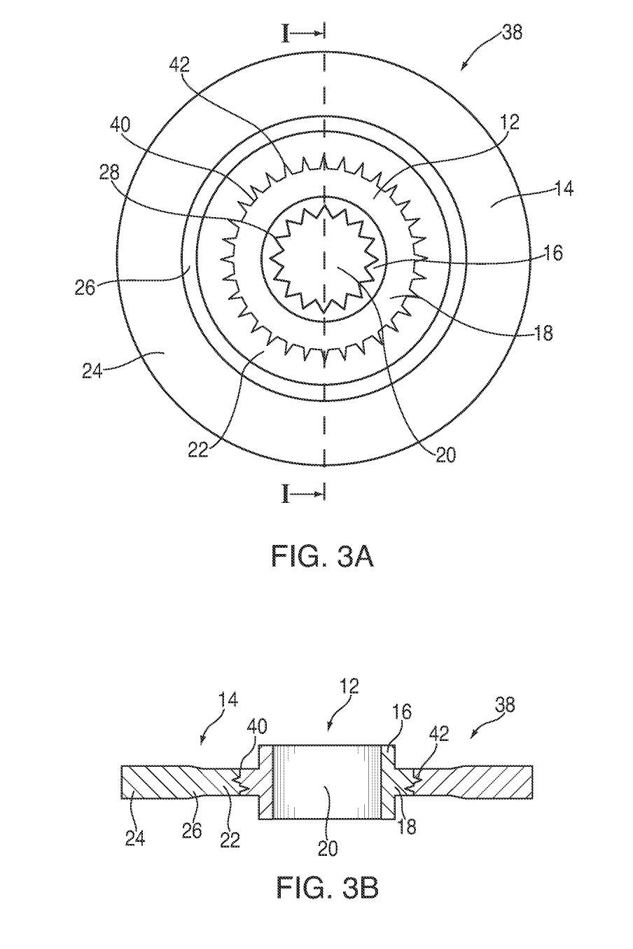

FIG. 3A shows a plan view of a brake rotor according to the invention as provided by a third exemplary embodiment of the invention; and

FIG. 3B shows a section through the brake rotor according to the invention on line I-I in FIG. 3A.

In the various figures of the drawing, components that correspond to one another are provided with the same reference numerals.

In FIG. 1A, a plan view of a brake rotor 10 according to the invention as provided by a first embodiment of the invention is shown. The brake rotor 10 according to the invention takes the form of a circular disk and comprises a central inner region 12 and an annular outer region 14 arranged concentrically on the central inner region. The inner region 12 has a central hub portion 16 and a first flange portion 18 adjoining the hub portion 16. The hub portion 12 comprises a through-opening 20, arranged concentrically with respect to the outer circumference of the brake rotor 10, for receiving a shaft to be braked (not shown). The annular outer region 14 comprises a second flange portion 22, a braking portion 24 and a transitional portion 26 located between the second flange portion 22 and the braking portion 24.

As shown in FIG. 1B, in the case of the exemplary embodiment represented the hub portion 16 has in the axial direction of the through-opening 20 a thickness which is approximately two to three times the thickness of the brake rotor 10 in the region of the braking portion 24. In the case of an embodiment represented, the thickness of the hub portion lies in the range from approximately 5 to 15 mm, particularly from approximately 10 to 15 mm. The first flange portion 18, adjoining the hub portion 16, of the inner region 12 has a thickness which lies in the range from approximately 2 to 10 mm and particularly at 5 mm. The second flange portion 22 of the outer region 14 has the same thickness as the first flange portion 18 of the inner region 12. However, it is also possible that, on one side of the brake rotor 10, the second flange portion 22 goes over gradually into the braking portion 24 with regard to its thickness. The braking portion 24 has a thickness which lies in the range between 5 and 15 mm and particularly at 10 mm.

Provided between the second flange portion 22 and the braking portion 24 of the outer region 14 is the transitional region 26, which creates a gradual transition between the thicknesses of the second flange portion 22 and the braking portion 24. However, it is also possible to choose the thickness of the hub portion 16 to be the same as the thickness of the braking portion 14, without this impairing the functional capability of the brake rotor 10. The narrowed intermediate region comprising the first and second flange portions 18 and 22 merely provides a reduced weight and a reduced mass moment of inertia of the brake rotor 10. It should be taken into consideration in particular that the thickness dimensions indicated in the exemplary embodiment depend very much on the area of use and on the size, that is to say in particular on the required diameter of the brake rotor 10. The diameter of the exemplary embodiment of the brake rotor 10 that is shown lies at approximately 100 mm. In the case of brake rotors with a larger diameter, corresponding greater thicknesses of the brake rotor 10 are also required.

In order to arrange the brake rotor 10 in a rotationally fixed, but axially displaceable manner on a shaft to be braked, for example on a shaft to be braked of a drive, the inner circumferential surface of the through-opening 20 is provided with teeth 28, which engage in corresponding teeth on a shaft to be braked.

Instead of the teeth 28 represented for the rotationally fixed mounting of the brake rotor 10 on a shaft, any other known noncircular form may also be chosen. For example, the shaft may have a shaft stub formed as a square or flattened and with an axial tongue, onto which the brake disk is then placed with a corresponding square opening or a flattened opening with a mating groove.

As shown in FIG. 1B, the central inner region 12 is produced from a first material composition of a fiber-reinforced thermoset (duroplast) and the annular outer region 14 is produced from a second material composition of a fiber-reinforced thermoset (duroplast). A phenoplastic polymer such as phenolic resin, phenolic/melamine resin or phenolic-resin-based epoxy resin may be used, for example, as the thermoset for this.

The first and second material compositions preferably contain 10 to 60% by weight, preferably 20 to 50% by weight, of reinforcing fibers, with respect to the weight of the brake rotor. The reinforcing fibers may be organic and/or inorganic fibers, for example glass fibers, ceramic fibers, alumina fibers, carbon fibers, aramid fibers, metallic fibers, plus cellulose fibers and mineral fibers or mixtures of these fibers. The reinforcing fibers preferably have an average fiber length of 3 to 15 mm, preferably 5 to 10 mm.

The second material composition, used in the case of the brake rotor according to the invention for the annular outer region 14, contains along with the reinforcing fibers, which may be based on metallic, inorganic or organic components, a heat-curing binder, preferably based on a modified phenolic resin, which may be mixed with melamine resins, polyamide compounds, epoxy resins, cresol resins, oil components, polyimides and crosslinkable polyacrylates and the like in quantities from 1 to 15% by weight. These friction materials also contain, as customary additives, lubricants such as graphite, molybdenum disulfide, barium sulfate, calcium carbonate or mixtures thereof in quantities of 10 to 25, preferably 15 to 20% by weight, abrasives based on oxides, nitrides or carbides, such as for example Al₂O₃, SiO₃, Cr₂O₃, Fe₂O₃, Fe₃O₄, ZrO₂, MgO, CaO, SiC, PM, PC, Si₃N₄ and AlN and mixtures thereof in quantities of 0.5 to 10% by weight, preferably 1 to 5% by weight. Furthermore, the second material composition may contain fillers such as barium sulfate or calcium sulfate, vulcanized or unvulcanized natural rubber or synthetic rubber in quantities of 1 to 15% by weight, preferably 5 to 10% by weight.

Consequently, the first material composition of the central inner region 12 is optimized to the extent that this region has a high strength, in particular a high tensile strength, in order to ensure an optimal force transmission from the hub portion 16 to a shaft to be braked, to avoid rupturing under high loading of the brake rotor 10 and to avoid vibrations. The second material composition of the outer region 14 is optimized to cover as wide a range as possible for the coefficient of friction, which lies in the range from 0.2 to 0.6, preferably between 0.3 and 0.5.

An optimized first material composition of the fiber-reinforced thermoset has a density in the range from 1.0 to 2.6 g/cm³, preferably 1.6 to 2.3 g/cm³ and particularly 2.1 g/cm³. The tensile strength of this material composition of the inner region 12 of the brake rotor 10 has a tensile strength of 50 to 200 N/mm², preferably 80 to 160 N/mm², and particularly 140 N/mm². The flexural strength lies in the range from 70 to 300 N/mm², preferably 220 to 260 N/mm² and particularly 240 N/mm². The first material composition of the fiber-reinforced thermoset also has, according to the invention, a compressive strength of 120 to 375 N/mm², preferably 300 to 350 N/mm², and particularly 325 N/mm².

The second material composition of the fiber-reinforced thermoset for the outer region 14 of the brake rotor 10 has a density of 1 to 2 g/cm³, preferably 1.4 to 1.8 g/cm³ and particularly 1.6 g/cm³. Furthermore, the tensile strength of the second material composition of the fiber-reinforced thermoset is 10 to 100 N/mm², preferably 10 to 50 N/mm², and particularly 29 N/mm². The flexural strength of the material is 10 to 100 N/mm², preferably 50 to 90 N/mm² and particularly 68 N/mm². The compressive strength of the second material composition is 50 to 150 N/mm², preferably 70 to 110 N/mm², and particularly 86 N/mm².

A brake rotor 10 with the parameters described above, which is formed on the basis of a fiber-reinforced thermoset and has additional friction materials in its outer region 14, shows under high mechanical and thermal loading both an optimal strength of the hub region 16 in the inner region 12, on account of the absence of additives to increase the friction factor, and an optimal frictional effect of the braking portion 24 of the outer region 14, while a good material bond between the two regions is additionally possible because of a high reaction affinity on the basis of covalent bonds.

As shown in FIGS. 1A and 1B, the transitional region 30 between the central inner region 12 with the first material composition and the annular outer region 14 with the second material composition lies in the narrowed region of the brake rotor 10, is therefore formed by the boundary surface between the radial outer side of the first flange portion 18 and the radial inner side of the second flange portion 22. This transitional region 30 between the two material compositions may, as shown in FIG. 1A, be arranged along a circular circumferential region, and extend straight through the brake rotor 10 in the axial direction.

As shown in FIGS. 2A and 2B, in the case of a brake rotor 32 according to a second exemplary embodiment of the invention, a force fit between the central inner region 12 and the outer region 14 can be further improved by providing not only a material bond between the two regions 12, 14 but also a form fit between the two interengaging regions. This configuration also has the effect of reducing vibrations that occur.

The brake rotor 32 corresponds substantially to the brake rotor 10 of the first exemplary embodiment of the invention, the only difference being that the transitional region 34 between the central inner region 12 with the first material composition and the radial outer region 14 with the second material composition is modified. As shown in FIG. 2A, the inner region 12 has a plurality of radially outwardly directed driver extensions 36, which extend in a star-shaped manner away from a circular inner portion of the inner region 12. The annular outer region 14 has radially inwardly directed driver extensions, which engage with a form fit in the driver extensions 36 of the inner region 12.

As shown in FIG. 2B, the transitional region 36 extends straight through the brake rotor 32 in the axial direction.

The brake rotor 10 according to the first exemplary embodiment of the invention and the brake rotor 32 according to the second exemplary embodiment of the invention are intended to serve merely as examples of a brake rotor with just a material bond between a central inner region and an annular outer region and of a brake rotor with a combined material bond and form fit between a central inner region and an annular outer region.

To optimize the force fit and inhibit vibrations between the central inner region 12 and the annular outer region 14, other suitable forms may also be provided as driver extensions, such as for example circular-segment forms, square forms, rhomboidal forms, heart-shaped forms, oval transitional forms or the like. In principle, both the arrangement and the number of driver extensions 36 can be chosen as desired. In this respect, more driver extensions may be provided in the case of larger brake rotor diameters than in the case of smaller diameters. In the case of the brake rotor represented, with a diameter of about 100 mm, the number of driver extensions expediently lies in the range from 2 to 50, particularly 20 to 40, and preferably at 32, these then also preferably being distributed uniformly in the circumferential direction, so that the dynamic behavior of the brake rotor is optimized both during rotation and during axial displacement. Furthermore, it is possible to provide involute teeth or trapezoidal teeth between the central inner region 12 and the annular outer region 14.

In FIGS. 3A and 3B, a brake rotor 38 according to a third exemplary embodiment of the invention is shown. The brake rotor 38 corresponds to the brake rotor 10 and the brake rotor 32 apart from a modified form of the transitional region 40 between the central inner region 12 and the annular outer region 14. In the case of this embodiment of the invention, schematically indicated irregular structures 42 have been introduced in the transitional region from the first material composition to the second material composition of the fiber-reinforced thermoset. These irregular structures may, for example, already be present before a connecting process between the inner region 12 and the outer region 14 or be introduced by mechanical treatment during the connecting process. In addition, it should be pointed out that the irregular structures 42 between the central inner region 12 and the annular outer region 14 may be created by a flowing of the thermoset. Consequently, in a practical configuration of the invention, irregular structures 42 between the inner region 12 and the outer region 14 in the transitional region 30 tend to be the norm and a perfectly smooth transitional region 30 the exception. The irregular structures 42 give the boundary surface between the inner region 12 and the outer region 14 in the transitional region 30 a roughness or graininess which further enhances the material bond on the basis of the form fit produced. Nevertheless, when a connection is made between the inner region 12 and the outer region 14, the affinity of the resins in the two regions results in an outstanding material bond, which can bear most of the mechanical load.

Therefore, the invention provides a brake rotor 10, 32 or 38, which has an inner region with high strength for high mechanical loading and an outer region with a braking portion with a high coefficient of friction between approximately 0.3 and 0.5 and with high compressibility and good tribological properties, the brake rotor being easy to produce and making a good force fit possible between the inner region and the outer region on the basis of a material bond and/or a form fit.

1. A brake rotor comprising:
a central inner region of a first material composition of a fiber-reinforced thermoset (duroplast), which has a hub portion with a concentric through-opening for receiving a shaft to be braked, and
an annular outer region, arranged concentrically on the central inner region, of a second material composition of a fiber-reinforced thermoset (duroplast), which has a braking portion with a friction surface,
the central inner region and the annular outer region being connected to each other with a material bond, and the central inner region being formed for transmitting high torques from the annular outer region to the shaft to be braked, and the annular outer region being optimized with regard to its tribological properties.

2. The brake rotor as claimed in claim 1, wherein the first material composition of the fiber-reinforced thermoset has a density of 1.0 to 2.6 g/cm³, a tensile strength of 50 to 200 N/mm², a flexural strength of 70 to 300 N/mm², and a compressive strength of 120 to 375 N/mm².

3. The brake rotor as claimed in claim 1, wherein the second material composition of the fiber-reinforced thermoset has a density of 1 to 2 g/cm³, a tensile strength of 10 to 100 N/mm², a flexural strength of 10 to 100 N/mm², and a compressive strength of 50 to 150 N/mm².

4. The brake rotor as claimed in claim 1, wherein the first and second material compositions of the fiber-reinforced thermoset contain phenoplastic polymers.

5. The brake rotor as claimed in claim 1, wherein the first and second material compositions of the fiber-reinforced thermoset contain 10 to 60% by weight, of reinforcing fibers, with respect to the overall weight of the brake rotor.

6. The brake rotor as claimed in claim 1, wherein the first and second material compositions of the fiber-reinforced thermoset contain at least one of organic and/of inorganic reinforcing fibers.

7. The brake rotor as claimed in claim 4, wherein the first and second material compositions of the fiber-reinforced thermoset contain as reinforcing fibers at least one of glass fibers, ceramic fibers, alumina fibers, carbon fibers, aramid fibers and metallic fibers, plus cellulose fibers and mineral fibers.

8. The brake rotor as claimed in claim 6, wherein the reinforcing fibers have an average fiber length of 3 to 15 mm.

9. The brake rotor as claimed in claim 1, wherein, along with the reinforcing fibers and a thermoset, the second material composition of the fiber-reinforced thermoset contains, as additives, lubricants such as graphite, molybdenum disulfide, barium sulfate, calcium carbonate or mixtures thereof, abrasives based on oxides, nitrides or carbides and fillers, such as barium sulfate or calcium sulfate, and vulcanized or unvulcanized natural rubber or synthetic rubber.

10. The brake rotor as claimed in claim 1, wherein the inner circumferential surface of the through-opening in the hub portion is provided with driving means for rotationally fixed mounting on a shaft to be braked.

11. The brake rotor as claimed in claim 10, wherein the driving means are formed by teeth for receiving shaft teeth on the shaft to be braked.

12. The brake rotor as claimed in claim 1, wherein both the central inner region and the annular outer region in the boundary region of the material-bonded transition between the first and second material compositions have a smaller thickness than that of the hub portion of the central inner region and that of the braking portion of the annular outer region.

13. The brake rotor as claimed in claim 1, wherein the central inner region has on its circumferential side one or more radially outwardly directed driver extensions, which are in form-fitting engagement with one or more radially inwardly directed driver extensions of the annular outer region.

14. The brake rotor as claimed in claim 1, wherein the central inner region and the annular outer region are connected to each other with a form fit by irregular structures in the transitional region from the first material composition to the second material composition of the fiber-reinforced thermoset.

15. The brake rotor as claimed in claim 2, wherein the first material composition of the fiber-reinforced thermoset has a density of 1.6 to 2.3 g/cm³, a tensile strength of 80 to 160 N/mm², a flexural strength of 220 to 260 N/mm², and a compressive strength of 300 to 350 N/mm².

16. The brake rotor as claimed in claim 15, wherein the first material composition of the fiber-reinforced thermoset has a density of 2.1 g/cm³, a tensile strength of 140 N/mm², a flexural strength of 240 N/mm², and a compressive strength of 325 N/mm².

17. The brake rotor as claimed in claim 3, wherein the second material composition of the fiber-reinforced thermoset has a density of 1.4 to 1.8 g/cm³, a tensile strength of 10 to 50 N/mm², a flexural strength of 50 to 90 N/mm², and a compressive strength of 70 to 110 N/mm².

18. The brake rotor as claimed in claim 17, wherein the second material composition of the fiber-reinforced thermoset has a density of 1.6 g/cm³, a tensile strength of 29 N/mm², a flexural strength of 68 N/mm², and a compressive strength of 86 N/mm².

19. The brake rotor as claimed in claim 4, wherein the phenoplastic polymers comprise phenolic resin, phenolic/melamine resin or phenolic-resin-based epoxy resin.

20. The brake rotor as claimed in claim 5, wherein the first and second material compositions of the fiber-reinforced thermoset contain 20 to 50% by weight, of reinforcing fibers, with respect to the overall weight of the brake rotor.

21. The brake rotor as claimed in claim 8, wherein the reinforcing fibers have an average fiber length of 5 to 10 mm.
